(19) United States
(12) Patent Application Publication
(10) Pub. No.: US 2025/0004836 A1
(43) Pub. Date: Jan. 2, 2025

(54) PROVIDING DEDICATED MEMORY ASSIGNMENTS TO APPLICATIONS

(71) Applicant: INTERNATIONAL BUSINESS MACHINES CORPORATION, ARMONK, NY (US)

(72) Inventors: HARRIS M. MORGENSTERN, WAPPINGERS FALLS, NY (US); ROBERT MILLER, JR., POUGHKEEPSIE, NY (US); DAVID HOM, POUGHKEEPSIE, NY (US); ELPIDA TZORTZATOS, LAGRANGEVILLE, NY (US); SCOTT BALLENTINE, POUGHKEEPSIE, NY (US); STEVEN M. PARTLOW, BEACON, NY (US); DIETER WELLERDIEK, AMMERBUCH (DE); CHRISTOPHER LEE WOOD, HYDE PARK, NY (US); NICHOLAS C. MATSAKIS, POUGHKEEPSIE, NY (US)

(21) Appl. No.: 18/342,006

(22) Filed: Jun. 27, 2023

(51) Int. Cl. G06F 9/50

(52) U.S. Cl. CPC G06F 9/5016; G06F 9/5044

(57) ABSTRACT

Providing dedicated memory assignments to applications is disclosed, including defining an area of dedicated memory within system memory, wherein frames of the dedicated memory are assignable to one or more programs; determining, in response to a program initializing, an amount of dedicated memory to assign to the program based on a dedicated memory parameter for the program; and assigning, based on the determined amount of dedicated memory, a portion of dedicated memory to the program, wherein the assigned portion of dedicated memory is dedicated to the program until program completion.

### BACKGROUND

### Field of the Disclosure

The field of the disclosure is memory management, or, more specifically, methods, apparatus, and products for providing dedicated memory assignments to applications.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Typically, when an application stores into or otherwise uses virtual memory, real memory is used to back the virtual memory. Real memory is returned to the system when either the application frees the virtual memory it is backing or the operating system reclaims the real storage by way of paging it to auxiliary memory or storage. This model does not provide exclusive use to an area of memory that can endure until program completion and therefore the program must compete with other applications for memory with every frame allocation.

### SUMMARY

Methods, apparatuses, and products for providing dedicated memory assignments to applications according to various embodiments are disclosed. providing dedicated memory assignments to applications can include: defining an area of dedicated memory within system memory, wherein frames of the dedicated memory are assignable to one or more programs; determining, in response to a program initializing, an amount of dedicated memory to assign to the program based on a dedicated memory parameter for the program; and assigning, based on the determined amount of dedicated memory, a portion of dedicated memory to the program, wherein the assigned portion of dedicated memory is dedicated to the program until program completion.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 a block diagram of an example computing system configured for providing dedicated memory assignments to applications in accordance with embodiments of the present disclosure.

FIG. 2 is a flowchart of an example method for providing dedicated memory assignments to applications according to some embodiments of the present disclosure.

FIG. 3A a block diagram of an example memory configuration for providing dedicated memory assignments to applications in accordance with embodiments of the present disclosure.

FIG. 3B a block diagram of an example memory configuration for providing dedicated memory assignments to applications in accordance with embodiments of the present disclosure.

FIG. 4 is a flowchart of an example method for providing dedicated memory assignments to applications according to some embodiments of the present disclosure.

FIG. 5 is a flowchart of an example method for providing dedicated memory assignments to applications according to some embodiments of the present disclosure.

### DETAILED DESCRIPTION

Real memory is managed by the operating system typically using the demand paging model; namely, when an application stores into or otherwise uses virtual memory, real memory is used to back the virtual memory. Real memory is returned to the system when either the application frees the virtual memory it is backing or the operating system reclaims the real storage by way of paging it to auxiliary memory or storage. This scheme presents drawbacks in that it makes no distinction between the applications competing for memory as memory is assigned on a first come first serve basis, and it makes no distinction between applications whose frames are selected for paging.

Some applications have irregular or unpredictable memory requirements and perform better when they are assigned real memory before starting, thus avoiding competition with other applications for memory. One such application is an operating system dump capture, which typically occurs unexpectedly when some system error occurs. Operating system dumps can preempt existing work in the system and thus it is beneficial to minimize the duration of the dump capture time. If the system is short of frames when the dump capture is initiated, capture time will increase since the system will need to steal frames from other applications, which is a very time-consuming process.

Embodiments in accordance with the present disclosure provide a mechanism for a portion of the total memory of a system to be designated as dedicated memory, effectively reserving memory for the exclusive use of a set of selected applications. The system administrator can select applications at the job step level where a job step is a program in execution and a job includes one or more sequential job steps. Once the job step starts, the application uses dedicated memory transparently. Page faults or other requests for real memory are satisfied from the dedicated memory pool if available and from the global pool of memory if not. Any dedicated memory that is not used is still for exclusive use by the job step. When the job step completes, the amount of dedicated memory owned by the job step is modified according to the requirements of the subsequent job step. All dedicated memory is returned to the system after the final job step (i.e. job end).

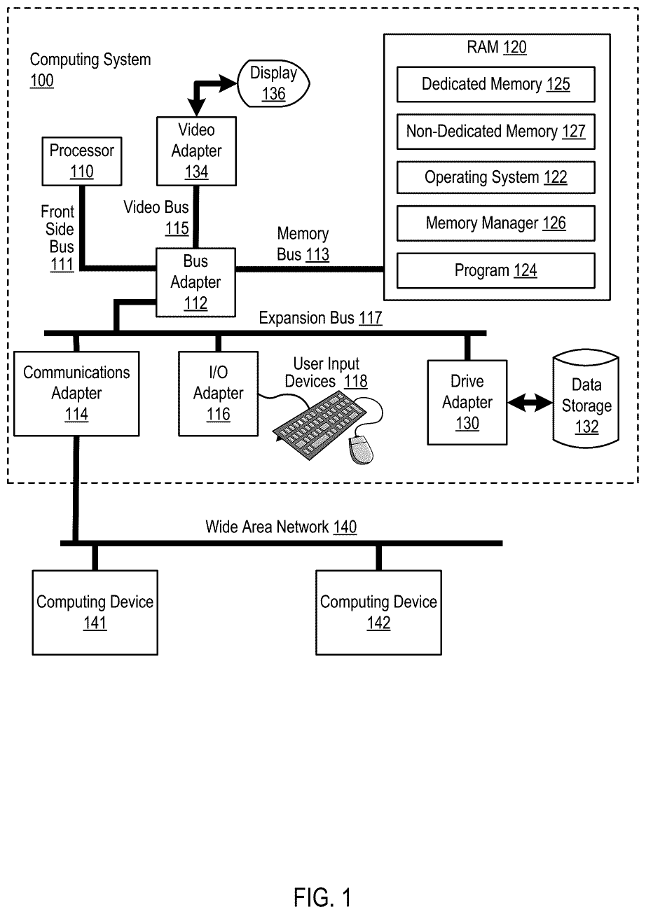

Exemplary apparatus and systems for providing dedicated memory assignments to applications in accordance with the present disclosure are described with reference to the accompanying drawings, beginning with FIG. 1. FIG. 1 sets forth a block diagram of automated computing machinery comprising an exemplary computing system 100 configured for providing dedicated memory assignments to applications according to embodiments of the present disclosure. The computing system 100 of FIG. 1 includes at least one computer processor 110 or ‘CPU’ as well as random access memory (‘RAM’) 120 which is connected through a high-speed memory bus 113 and bus adapter 112 to processor 110 and to other components of the computing system 100. An area of RAM 120 is reserved for dedicated memory 125, as will be explained in more detail below. Dedicated memory 125 is assigned to a program and is not freed until the program completes. RAM 120 also includes non-dedicated memory 127 that behaves like conventional memory where memory is allocated and freed during program execution based on, for example, a demand paging model.

Stored in RAM 120 is an operating system 122. Operating systems useful in computers configured for providing dedicated memory assignments to applications according to embodiments of the present disclosure include z/OS™, UNIX™, Linux™, Microsoft Windows™. AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is a program 124 configured to use dedicated memory.

Also stored in RAM is a memory manager 126. The memory manager 126 is embodied in a set of processor-executable instructions that, when executed by the processor 110, causes the computing system 100 to carry out the steps of defining an area of dedicated memory within system memory, wherein frames of the dedicated memory are assignable to one or more programs; determining, in response to a program initializing, an amount of dedicated memory to assign to the program based on a dedicated memory parameter for the program; and assigning, based on the determined amount of dedicated memory, a portion of dedicated memory to the program, wherein the assigned portion of dedicated memory is dedicated to the program until program completion. The area of dedicated memory is physical memory referenced by a physical address space. In some examples, the dedicated memory parameter is based on historical memory information for the program. In some examples, the dedicated memory parameter indicates a minimum amount of dedicated memory and a target amount of dedicated memory. In some cases, commencement of the program is canceled when the minimum amount of dedicated memory is not available.

In some examples, the processor-executable instructions cause the computer to carry out the steps of receiving, from the program, a memory allocation request; determining whether the memory allocation request can be fulfilled using dedicated memory; allocating, to the program, memory from the portion of dedicated memory when the memory allocation can be fulfilled using dedicated memory; and allocating, to the program, memory from non-dedicated memory when the memory allocation cannot be fulfilled using dedicated memory.

In some examples, the processor-executable instructions cause the computer to carry out the steps of identifying, in response to completing the program, a subsequent program in a sequence of programs; and determining, based on a dedicated memory parameter for the subsequent program, how much of the portion of dedicated memory to assign the subsequent program. The program and the subsequent program may be job steps of a job. In some cases, at least some of the portion of dedicated memory is assigned to the subsequent program. In some cases, at least some of the portion of dedicated memory is freed based on a target amount of dedicated memory for the subsequent program. In some cases, an additional portion of dedicated memory is assigned to the subsequent program based on a target amount of dedicated memory for the subsequent program. In some cases, the subsequent program is canceled when there is insufficient available dedicated memory to satisfy a minimum amount of dedicated memory for the subsequent program.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

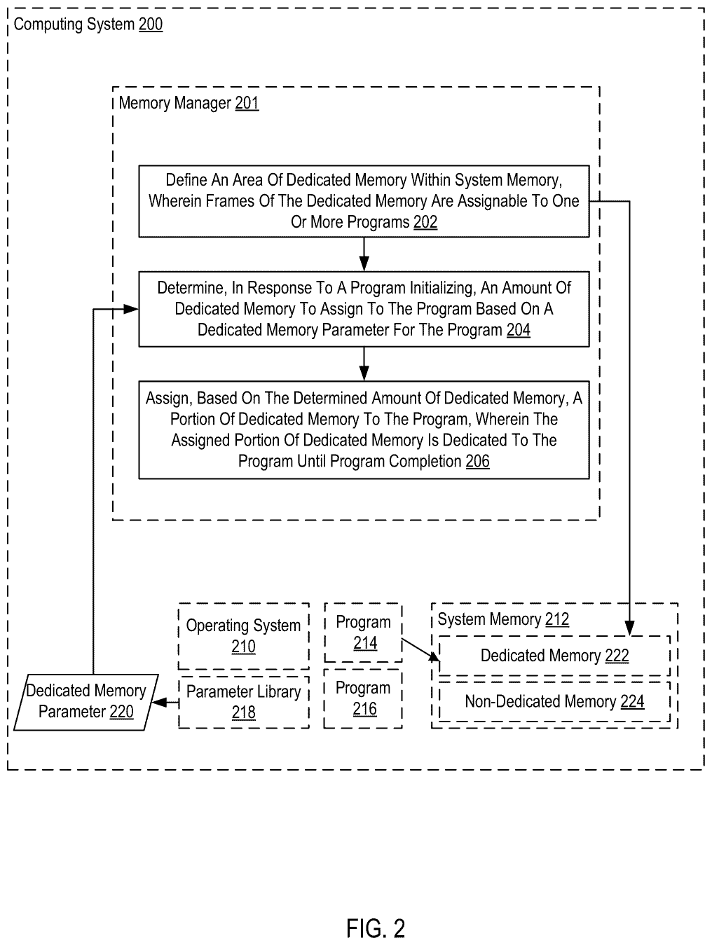

For further explanation, FIG. 2 sets forth a flowchart illustrating an example method of providing dedicated memory assignments to applications according to embodiments of the present disclosure. The example of FIG. 2 is described in the context of an example computing system 200 (e.g., the example computing system 100 of FIG. 1). The example computing system 200 may be based on, for example, the z/Architecture offered by International Business Machines (IBM). However, the use of such an architecture is provided only as one example for the computer system 200 and is not intended to limit the scope of the present disclosure. The computing system 200 includes an operating system 210 (e.g., the operating system 122 of FIG. 1) and a memory manager 201 configured to provide dedicated memory assignments to applications. In a particular example, the operating system 210 may be the z/OS operating system. The memory manager 201 may be a component of the operating system 210 or a separate module.

The example computing system 200 also includes one or more programs 214, 216. In some examples, the programs 214, 216 are applications embodied by a set of computer program instructions. In further examples, the programs 214, 216 are job step programs of the same job. For example, the operating system 210 may be configured to initiate a job by loading a job step program and, upon completion of that job step program, load the next job step program. This continues until the job completes.

The example computing system 200 also includes a parameter library 218 (e.g., the parmlib in the z/OS operating system) that includes configuration parameters for the programs 214, 216. For example, the configuration parameters for a program may include resources and resource limits for that program. In one example, a configuration parameter for a program may limit the amount of virtual memory utilized by the program. As will be explained in more detail below, a configuration parameter for a program may indicate the dedicated memory for the program. In some examples, the parameters in the parameter library 218 are configured by a user such as a system administrator. The parameter library 218 may be a file that is maintained and referenced by the operating system 210.

The example computing system 200 also includes system memory 212. The system memory 212 is comprised of real memory (e.g. physical RAM). The system memory 212 includes a system use area of memory (e.g., including operating system and system component address spaces) and a global pool of memory that is shared by applications or programs. This global pool of shared memory is referred to herein as ‘non-dedicated memory.’ The non-dedicated memory 224 in the computing system 200 is subject to the drawbacks of conventional memory management mechanisms. That is, memory requests (e.g., page faults) as satisfied on a first come first served basis and programs may be forced to wait for such requests to be satisfied, for example, during memory usage spikes. In the demand paging model, for example, when a program uses virtual memory, real memory is used to back the virtual memory. Real memory is returned to the system when either the program frees the virtual memory it is backing or the operating system reclaims the real memory by way of paging it to auxiliary storage. Such a model makes no distinction between the applications competing for memory and makes no distinction between programs whose frames are selected for paging.

To address such issues, the method of FIG. 2 includes defining 202 an area of dedicated memory 222 within system memory 212, wherein dedicated memory 222 is assignable to one or more programs. Dedicated memory 222 is assignable in that once dedicated memory has been assigned to a program, the dedicated memory remains assigned to the program and is not freed until program completion. Thus, assigned dedicated memory remains in program control regardless of whether the program is utilizing all of the assigned dedicated memory. In some examples, a memory manager 201 defines 202 an area of dedicated memory 222 by first reading a dedicated memory configuration parameter that indicates how much dedicated memory to configure in the computing system 200. For example, the dedicated memory configuration parameter may be located in a parameter library such as the parameter library 218. The dedicated memory configuration parameter may be selected by a user through an interface that writes the dedicated memory configuration parameter, including the amount of dedicated memory to assign, to the parameter library. In some examples, the amount of dedicated memory is based on multiples of a particular frame size such as, for example, 2 gigabytes (GB), where that frame size is the increment by which dedicated memory is assigned. This frame size may also correspond to the largest page size supported by the operating system 210. Thus, the dedicated memory frame size is larger than the nominal real memory frame size (e.g., 4 kilobytes (KB)).

In some examples, the amount of dedicated memory to define is based on historical memory usage of programs that will utilize dedicated memory. For example, the user can query the operating system 210 for system maintenance records or logs that indicate data regarding memory utilization of a program. Such data can include a high-water mark of the number of real storage frames (e.g., 4 KB frames) that are used to back 64-bit private memory, a high water mark of the number of auxiliary memory frames that are used to back 64-bit private memory, a high-water mark of the number of 2 GB frames used by a particular program, and the number of 2 GB frames that could not be obtained because none were available at the time of a memory allocation request. In the z/OS operating system, such information may be identified from system maintenance facility (SMF) records. The user can then identify a target dedicated memory allotment for each program and sum these amounts to select the total amount of dedicated memory to assign. In an alternative example, a script may be used to query memory usage records for a list of programs that will utilize dedicated memory and automatically generate recommended amounts of dedicated memory to assign to those programs. In such an example, the memory manager 201 may calculate an amount of dedicated memory to define. Once the user is aware of the dedicated memory that will be utilized by programs, the user can select an amount of dedicated memory to define on the system and store this number as the dedicated memory configuration parameter.

To aid illustration, consider an example using the z/OS operating system where the user analyzes historical memory usage statistics of critical applications using SMF records. The user then specifies, based on the historical analysis program dedicated memory parameters in the parmlib to indicate both target and minimum amounts of dedicated memory for specific job steps. The user also specifies, in the parmlib, the dedicated memory configuration parameter indicating the total amount of dedicated memory to define on the system based on which job steps are to be assigned dedicated memory. Upon the user starting the initial program load (IPL) (i.e., the operating system load), the memory manager requests system parameters from the parameter library and reads the dedicated memory configuration parameter. The memory manager then generates a dedicated memory configuration based on the dedicated memory configuration parameter and displays the memory configuration, giving the user the opportunity to respecify the parameters and/or redo the IPL.

In some examples, the user defines a target amount of dedicated memory and a minimum amount of dedicated memory for each program (e.g., job step) that will utilize dedicated memory. For example, the user may write a dedicated memory parameter for a program to a parameter library such as the parameter library 218. The dedicated memory parameter may include the target amount and minimum amount of memory for the program. The memory manager 201 will use this parameter when assigning dedicated memory to the program, first attempting to meet the target amount. In some examples, the program will not commence if the minimum amount of dedicated memory cannot be assigned; however, the minimum amount may also be specified as zero. The target amount and minimum amount of dedicated memory may be based on historical usage as discussed above.

In one example, during dedicated memory initialization, the memory manager 201 reads the parameter library specification of the amount of dedicated memory and reserves the specified amount of memory starting from the highest real memory address to descending addresses. This process may be performed prior to processing any other memory related parameters. It is possible that ranges within the dedicated memory area to be offline. Later in the system initialization process when multiple processors are brought online, the dedicated memory area is initialized and represented in a page frame table. This allows other components of the operating system, middleware and perhaps even applications, to initialize concurrently.

In one example, it is possible for an application that is eligible for a dedicated memory assignment initializes before dedicated memory is initialized. In such an example, the memory manager 201 is already aware how much dedicated memory will eventually be initialized. As such, it allows the application to initialize with less than the minimum required amount if the minimum amount could be satisfied once dedicated memory has completed initialization. However, the program that is initializing must wait for memory initialization to complete. In some examples, the operating system 210 provides a service that, when invoked by a program, polls to determine whether real memory has completed initialization and waits intermittently. After dedicated memory initialization is complete, the memory manager 201 determines whether any program that has already started has requested dedicated memory and whether the program's minimum dedicated memory has not been met. If the minimum has not been met, the memory manager 201 will assign at least enough dedicated memory to meet the minimum.

The method of FIG. 2 also includes determining 204, in response to a program 214 initializing, an amount of dedicated memory to assign to the program 214 based on a dedicated memory parameter 220 for the program 214. When the operating system 210 initializes a program, the operating system 210 reads the parameter library to identify the dedicated memory parameter for the program. As discussed above, the dedicated memory parameter 220 indicates the target amount of dedicated memory for the program and the minimum amount of dedicated memory for the program. The memory manager 201 determines how much dedicated memory can be assigned to the program based on these values and the available dedicated memory eligible for assignment. In some examples, the memory manager 201 will first determine whether the target amount of dedicated memory for the program can be satisfied. If it cannot, the memory manager 201 will determine how much available dedicated memory can be assigned to the program such that the minimum amount of dedicated memory can be satisfied. If the minimum amount of dedicated memory cannot be assigned, the program is canceled and will not commence. Otherwise, all available dedicated memory be assigned to the program such that the amount of dedicated memory that is assigned is between the minimum amount and the target amount.

The method of FIG. 2 also includes assigning 206, based on the determined amount of dedicated memory, a portion of dedicated memory to the program 214, wherein the assigned portion of dedicated memory is dedicated to the program 214 until program completion. In some examples, the memory manager 201 assigns frames of dedicated memory to the program based on the determined amount of memory to be assigned. Once the portion of dedicated memory is assigned, the entire portion of assigned dedicated memory is available for use by the program and will not be freed until the program ends. For example, frames of dedicated memory cannot be ‘stolen’ or reallocated to a different program even if those frames are not in use by the program. The assignment of dedicated memory frames may be recorded, for example, in a page frame table. The portion of dedicated memory assigned can include both contiguous and noncontiguous frames.

Example installations that benefit from dedicated memory include: installations that are concerned about applications with irregular or unpredictable memory usage, such as operating system dump captures (e.g., SVC dump capture); installations that want to preferentially assign memory to certain applications that exploit high virtual storage (e.g., z/CX containers); and installations that want to exploit large amounts (e.g., greater than 4 T) of memory (e.g., in-memory databases). Dedicated memory is useful in providing a program with guaranteed ownership of memory and is particularly suited for programs where the required amount of memory is fixed or readily estimated, such as containers (e.g., z/CX containers), virtual machines, and in-memory databases. For example, the memory used by containers and virtual machines may be a fixed size.

There may be additional considerations for using dedicated memory. In some z/OS operating system implementations, dedicated memory may be used transparently to back any private memory object as long as the memory object is freed at end of job step, i.e., owned by the job step task or a descendent. Thus, when dedicated memory is freed at the end of a step, the virtual memory that the dedicated memory backs must also be freed. Dedicated memory may be used transparently to back page tables of such memory objects. Dedicated memory may be used to back any private memory object if the address space is a single step started task (and also any dynamic address translation tables), such as DUMPSRV and z/CX containers on the z/OS platform. Dedicated memory is never paged/stolen as program owns the memory until end of job step, regardless of whether it actually uses the memory.

In some examples, the pool of dedicated memory can be reconfigured offline if it is not assigned to a program or job step. An attempt to configure assigned dedicated memory offline will result in the command being waited until either the program that is assigned the memory completes or the command to reconfigure the memory is cancelled. If the user specifies an amount, instead of specific ranges of dedicated memory to configure offline, the system will select memory increments are not assigned to a program, where those increments are configurable units of real memory. In one example, a minimum increment size for dedicated memory configuration is 2 GB. Once dedicated memory is configured offline for one partition, it may be configured online on another partition either as non-dedicated memory or dedicated memory, depending how the memory is defined in the target system.

Dedicated memory is independent of non-dedicated memory, thus the management of dedicated memory uses dedicated memory and little non-dedicated memory. In some examples, dedicated memory that is used to manage dedicated memory is referred to as System Assigned memory. System assigned dedicated memory can be configured offline, but only if it is not being used to manage dedicated memory that is assigned to a job step. In effect, this allows the entire pool of dedicated memory to be configured offline when none of it is assigned to a program. Conversely when some dedicated memory is assigned to a program, the system assigned dedicated Memory that is being used to manage the other assigned memory may not be configured offline.

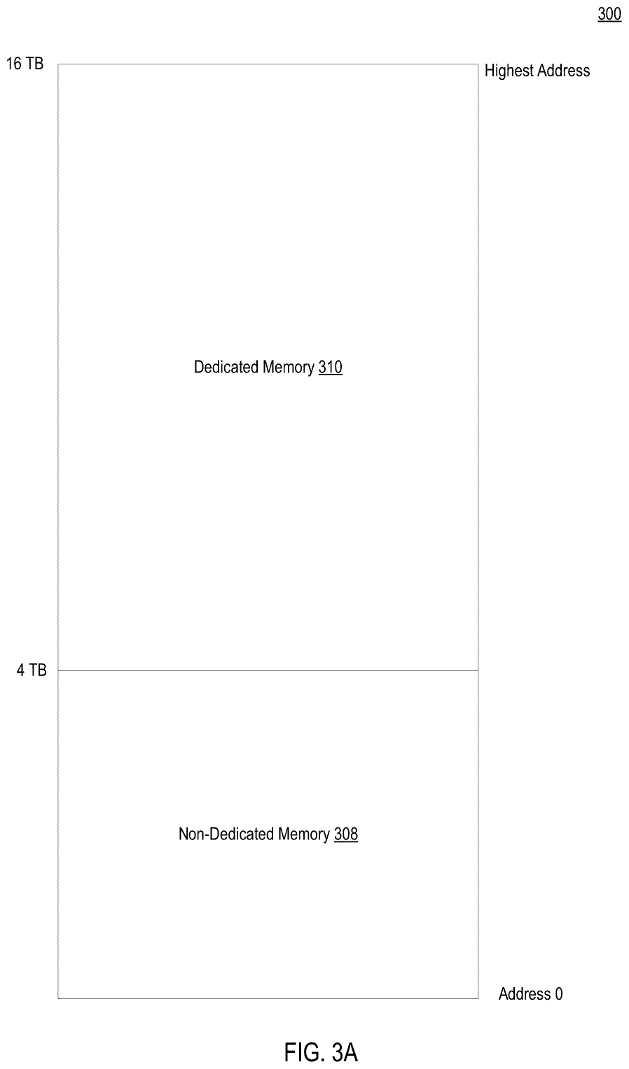

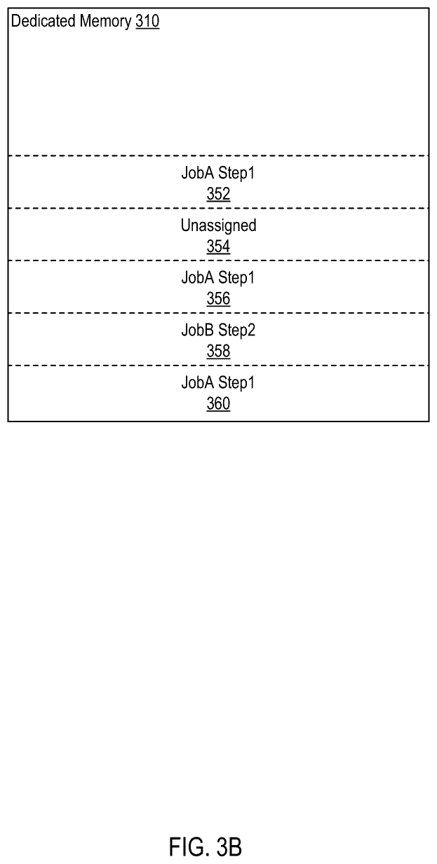

For further reference, FIG. 3A sets forth a block diagram of an example memory configuration 300 for providing dedicated memory assignments to applications in accordance with some embodiments of the present disclosure. The example memory configuration 300 includes 16 terabytes (TB) of system memory. The lower 4 TB include, beginning at the highest address in the lower 4 TB, a non-dedicated memory area 308. An area of dedicated memory 310 begins at the highest memory address and occupies the upper 12 TB of system memory.

For further reference, FIG. 3B sets forth a block diagram of an example memory configuration for providing dedicated memory assignments to applications in accordance with some embodiments of the present disclosure. The example memory configuration includes an area of dedicated memory 310 from which a job step program 1 of job A is assigned three frames 352, 356, 360 of dedicated memory. Job step program 2 of job B is assigned one frame 358 of dedicated memory. Another frame 354 is unassigned.

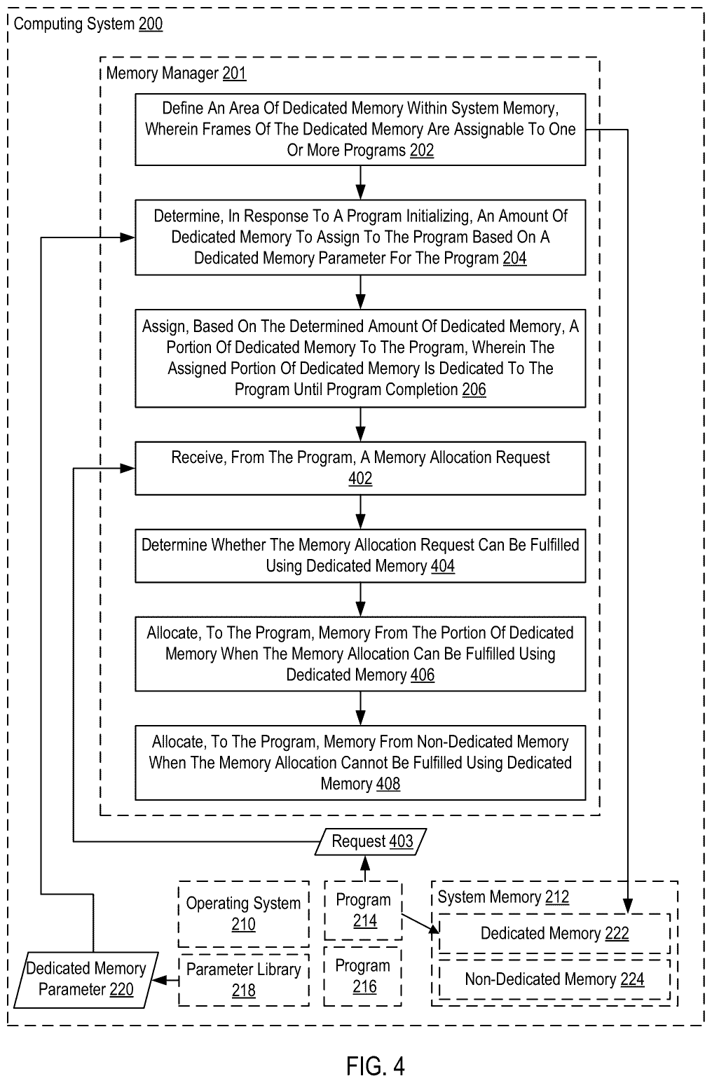

Once the program has initialized and received an assignment of dedicated memory, that program can begin using the dedicated memory. For further reference, FIG. 4 sets forth a flow chart of another example method of providing dedicated memory assignments to applications in accordance with some embodiments of the present disclosure. The method of FIG. 4 extends the method of FIG. 2 in that the method of FIG. 4 further includes receiving 402, from the program 214, a memory allocation request 403. In some examples, the memory manager 201 receives a request 403 from the program 214 to allocate a memory object such as a page.

The method of FIG. 4 also includes determining 404 whether the memory allocation request 403 can be fulfilled using dedicated memory. In some examples, the memory manager 201 compares the size of the memory object that is requested and compares the amount request to the amount of available dedicated memory in the assigned portion of dedicated memory.

The method of FIG. 4 also includes allocating 406, to the program 214, memory from the portion of dedicated memory when the memory allocation request 403 can be fulfilled using dedicated memory. In some examples, the memory manager 201 allocates the memory object from dedicated memory when there is sufficient dedicated memory available in the assigned portion of dedicated memory. For example, the memory manager 201 may allocate a 2 GB, 1 MB, or 4 KB frame of dedicated memory to the program from the program's assigned portion.

The method of FIG. 4 also includes allocating 408, to the program 214, memory from non-dedicated memory when the memory allocation request 403 cannot be fulfilled using dedicated memory. In some examples, when there is insufficient dedicated memory to fulfill the memory allocation request 403, the memory manager allocates the memory object from non-dedicated memory. For example, the memory manager 201 allocates a page from non-dedicated memory. However, the memory backing this page will be freed for use by other programs when the program releases it rather than remaining assigned to the program for reuse.

Dedicated memory assigned to the program is managed using a ‘buddy system’ memory allocation scheme where 2 GB frames can be split into smaller frame sizes depending on the demands of the program. For example, 2 GB frames can be split into 1 MB frames and 1 MB frames can be split into 4 KB frames. When frames are returned to the system, adjacent frames are passively reformed into 2 GB frames. In some examples, if the application requests a 2 GB or 1 MB frame and such a frame is not available, the memory manager 201 will back virtual memory from the non-dedicated memory pool instead of demoting the page and satisfying it with a smaller frame size. Upon completion of the program, all dedicated memory assigned to the program is reformed back into 2 GB frames.

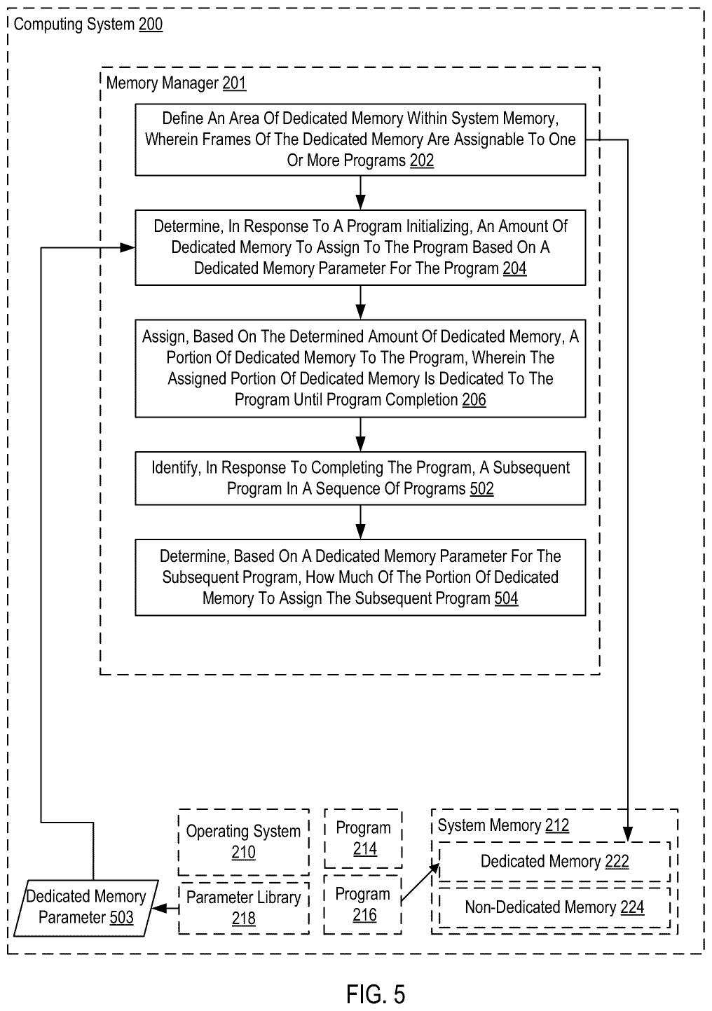

Once the program has completed, the dedicated memory assigned to the program may be assigned to a related program such as another job step of the same job. For further reference, FIG. 5 sets forth a flow chart of another example method of providing dedicated memory assignments to applications in accordance with some embodiments of the present disclosure. The method of FIG. 5 extends the method of FIG. 2 in that the method of FIG. 5 further includes identifying 502, in response to completing the program 214, a subsequent program 216 in a sequence of programs. Programs 214, 216 may be related as job steps of the same jobs, programs belong to the same batch processing routine, or in other ways where a second program begins in response to a first program completing. In some examples, when a program 214 ends, the memory manager 201 determines whether there is a next program in a sequence of programs. For example, where the programs are job step programs, the memory manager 201 determines whether there is another job step program in the job. If there is no other subsequent program or the program was a single step task, the memory manager 201 frees the portion of dedicated memory that was assigned to the completed program 214. When there is a subsequent program, all or part of the portion of dedicated memory that is assigned to the first program can be assigned to the next program.

The method of FIG. 5 also includes determining 504, based on a dedicated memory parameter 503 for the subsequent program 216, how much of the portion of dedicated memory to assign the subsequent program 216. In some examples, the memory manager identifies the target amount of dedicated memory for the subsequent program 216 from the dedicated memory parameter for that program 216. The memory manager compares the target amount to the amount of dedicated memory currently assigned to the first program 214. If the target amount of dedicated memory for the second program 216 is less than that assigned to the first program 214, the memory manager 201 frees an amount of dedicated memory in excess of the target amount.

If the target amount of dedicated memory for the second program 216 is equal to or greater than that assigned to the first program, the memory manager determines how much additional dedicated memory is required to satisfy the target amount. If there is enough available dedicated memory to satisfy the target amount of the second program, the portion of dedicated memory assigned to the first program 214 is assigned to the second program 216 as well as the additional amount of dedicated memory needed to satisfy the target amount. If there is not enough available dedicated memory to satisfy the target amount for the second program 216 but there is enough available to satisfy the minimum amount indicated in the dedicated memory parameter 503, the portion of dedicated memory assigned to the first program 214 is assigned to the second program 216 as well as all available dedicated memory. If there is not enough available additional dedicated memory to satisfy the minimum amount, the second program 216 is canceled.

To facilitate dedicated memory configuration and instrumentation, the operating system 210 may include an API for an authorized service to obtain information about real storage usage, an API for an unauthorized service to wait for dedicated memory initialization to complete, and an API for authorized service to obtain system information about dedicated memory usage.

The operating system 210 may provide interfaces for accessing statistical records related to dedicated memory of a program. Examples of such statistical records (e.g., SMF type 30 records in the z/OS operating system) may include requested dedicated memory in 2 GB units at start of the program; requested minimum amount of dedicated memory in 2 GB units at start of the program; assigned dedicated memory in 2 GB units at start of the program; number of 2 GB dedicated memory frames in use; the number of fixed 1 MB dedicated memory frames in use; the number of pageable 1 MB dedicated memory frames in use; the number of 4 KB dedicated memory frames in use; the number of 4 KB dedicated memory frames in use as DAT tables; a high water mark for the number of dedicated real storage frames (4 KB units) that is used to back 64-bit private storage; a high water mark for the number of dedicated real storage frames (1 MB units) that are used to back Pageable 1 MB pages; a high water mark for the number of dedicated real storage frames (1 MB units) that are used to back fixed 1 MB pages; a high water mark for the number of dedicated real storage frames (4 KB units) that are used to back 2 GB pages; a high water mark of the number of dedicated real storage frames (4 KB units) that are used to back DAT tables; a high water mark of the number of dedicated memory frames in use in 4 KB units; a count of requested 2 GB frames eligible to backed by dedicated memory frames but were not due to availability; a count of requested 1 MB frames eligible to backed by dedicated memory frames but were not due to availability; a count of requested 4 KB frames eligible to backed by dedicated memory frames but were not due to availability; a high water marl of the number of 2 GB frames in use by the program; and the number of 2 GB frames that could not be obtained because none were available at the time of a memory allocation request. This data provides a historical basis for estimating the amounts of dedicated memory for a program. In some implementations, the operating system or memory manager parses these data records to automatically determine a target and minimum amount of dedicated memory for a program.

The operating system 210 may gather data related to dedicated memory usage on the system and store the data in records (e.g., SMF type 71 records in the z/OS operating system) that can be accessed through interfaces to retrieve such data. Examples of such data may include the total amount of dedicated memory at system initialization that can be used by address spaces in 2 GB units; an minimum/maximum/average number of address spaces using dedicated memory; minimum/maximum/average amounts of online and offline dedicated memory in 2 GB units, including dedicated memory used by the system; minimum/maximum/average amounts of online dedicated memory in 2 GB units, including dedicated memory used by the system; minimum/maximum/average amounts of available dedicated memory in 2 GB units that can be used by address spaces; minimum/maximum/average amounts of requested dedicated memory in 2 GB units over all address space; the lowest/highest/average minimum amount of requested dedicated memory in 2 GB units over all address spaces; minimum/maximum/average amounts of assigned dedicated memory over all address spaces; minimum/maximum/average amounts of dedicated memory used as 2 GB frames over all address spaces; minimum/maximum/average amounts of dedicated memory used as 1 MB fixed frames over all address spaces; minimum/maximum/average amounts of dedicated memory used as 1 MB pageable frames over all address spaces; minimum/maximum/average amounts of dedicated memory used as 4 KB frames over all address spaces; the minimum/maximum/average number of frames in 4 KB units backing DAT tables (system use).

In view of the explanations set forth above, readers will recognize a number of advantages of providing dedicated memory assignments to applications according to embodiments of the present disclosure including:
Providing a mechanism to define a pool of dedicated memory on a system.
Providing a mechanism to assign dedicated memory to programs at a per-program level.
Providing a mechanism to ensure that programs have sufficient memory.
Avoiding irregular memory usage and memory spikes that slows other work on a system.

Exemplary embodiments of the present disclosure are described largely in the context of a fully functional computer system for optimizing network load in multicast communications. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of providing dedicated memory assignments to applications comprising:
defining an area of dedicated memory within system memory, wherein frames of the dedicated memory are assignable to one or more programs;
determining, in response to a program initializing, an amount of dedicated memory to assign to the program based on a dedicated memory parameter for the program; and
assigning, based on the determined amount of dedicated memory, a portion of dedicated memory to the program, wherein the assigned portion of dedicated memory is dedicated to the program until program completion.

2. The method of claim 1, wherein the area of dedicated memory is physical memory.

3. The method of claim 1, wherein the dedicated memory parameter is based on historical memory information for the program.

4. The method of claim 1, wherein the dedicated memory parameter indicates a minimum amount of dedicated memory and a target amount of dedicated memory.

5. The method of claim 1 further comprising:
receiving, from the program, a memory allocation request;
determining whether the memory allocation request can be fulfilled using dedicated memory;
allocating, to the program, memory from the portion of dedicated memory when the memory allocation can be fulfilled using dedicated memory; and
allocating, to the program, memory from non-dedicated memory when the memory allocation cannot be fulfilled using dedicated memory.

6. The method of claim 1 further comprising:
identifying, in response to completing the program, a subsequent program in a sequence of programs; and
determining, based on a dedicated memory parameter for the subsequent program, how much of the portion of dedicated memory to assign the subsequent program.

7. The method of claim 6, wherein the program and the subsequent program are job steps of a job.

8. The method of claim 6, wherein at least some of the portion of dedicated memory is assigned to the subsequent program.

9. The method of claim 8, wherein at least some of the portion of dedicated memory is freed based on a target amount of dedicated memory for the subsequent program.

10. The method of claim 8, wherein an additional portion of dedicated memory is assigned to the subsequent program based on a target amount of dedicated memory for the subsequent program.

11. The method of claim 6, wherein the subsequent program is canceled when there is insufficient available dedicated memory to satisfy a minimum amount of dedicated memory for the subsequent program.

12. An apparatus for providing dedicated memory assignments to applications, the apparatus comprising a computer processor, a computer memory operatively coupled to the computer processor, the computer memory having disposed therein computer program instructions that, when executed by the computer processor, cause the apparatus to carry out the steps of:
defining an area of dedicated memory within system memory, wherein frames of the dedicated memory are assignable to one or more programs;
determining, in response to a program initializing, an amount of dedicated memory to assign to the program based on a dedicated memory parameter for the program; and
assigning, based on the determined amount of dedicated memory, a portion of dedicated memory to the program, wherein the assigned portion of dedicated memory is dedicated to the program until program completion.

13. The apparatus of claim 12, wherein the dedicated memory parameter indicates a minimum amount of dedicated memory and a target amount of dedicated memory.

14. The apparatus of claim 12 further comprising:
receiving, from the program, a memory allocation request;
determining whether the memory allocation request can be fulfilled using dedicated memory;
allocating, to the program, memory from the portion of dedicated memory when the memory allocation can be fulfilled using dedicated memory; and
allocating, to the program, memory from non-dedicated memory when the memory allocation cannot be fulfilled using dedicated memory.

15. The apparatus of claim 12 further comprising:
identifying, in response to completing the program, a subsequent program in a sequence of programs; and
determining, based on a dedicated memory parameter for the subsequent program, how much of the portion of dedicated memory to assign the subsequent program.

16. The apparatus of claim 15, wherein the program and the subsequent program are job steps of a job.

17. The apparatus of claim 15, wherein at least some of the portion of dedicated memory is assigned to the subsequent program.

18. A computer program product for providing dedicated memory assignments to applications, the computer program product disposed upon a computer readable medium, the computer program product comprising computer program instructions that, when executed, cause a computer to carry out the steps of:
defining an area of dedicated memory within system memory, wherein frames of the dedicated memory are assignable to one or more programs;
determining, in response to a program initializing, an amount of dedicated memory to assign to the program based on a dedicated memory parameter for the program; and
assigning, based on the determined amount of dedicated memory, a portion of dedicated memory to the program, wherein the assigned portion of dedicated memory is dedicated to the program until program completion.

19. The computer program product of claim 18, wherein the dedicated memory parameter indicates a minimum amount of dedicated memory and a target amount of dedicated memory.

20. The computer program product of claim 18, wherein the area of dedicated memory is physical memory.
